(19) United States
(12) Patent Application Publication
(10) Pub. No.: US 2003/0154624 A1
(43) Pub. Date: Aug. 21, 2003

(54) Drying hopper

(76) Inventor: Charles F. Sears JR., Tolland, CT (US)

Correspondence Address: McCormick, Paulding & Huber, City Place II, 185 Asylum Street, Hartford, CT, 06103-3402, US

(21) Appl. No.: 10/079,952

(22) Filed: Feb. 19, 2002

(51) Int. Cl. F26B 17/00

(52) U.S. Cl. 34/577; 34/583

(57) ABSTRACT

A drying hopper for plastic resin pellets has an inverted frusto-conical lower section and a diffuser with an inverted frusto-conical lower section and an inverted upright frusto-conical upper section. A supply conduit is connected to the upper section and to a source of heated drying air. An inverted frusto-conical basket is disposed in the hopper in spaced relationship with the lower portion of the diffuser and also in spaced relationship with the lower portion of the hopper. The basket is perforated so that a through flow of heated drying air occurs across an annular frusto-conical passageway for drying of the pellets. The air flow outwardly through the lower end portion of the diffuser passes substantially continuously through the pellets and across the passageway for final highly efficient drying of the pellets and thence to a space outwardly of the basket and upwardly for initial drying of the pellets in the hopper thereabove.

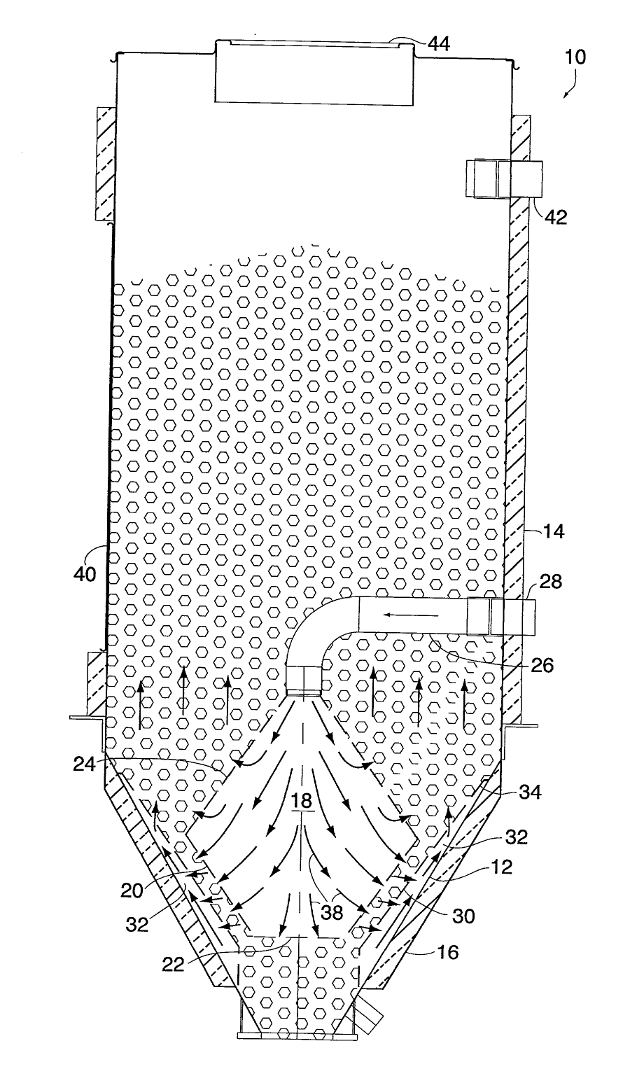

### FIELD OF THE INVENTION

The present invention relates to a drying hopper for pelletized plastic resins used in molding and extruding processes.

### BACKGROUND OF THE INVENTION

In conditioning plastic resins for molding or extruding processes, the pellets are introduced into a drying hopper and dried for a period of time prior to processing. Specific temperatures and drying times are required for different resins. For example, Polycarbonate dries at approximately 250° F. for 30 minutes while Nylon must be dried at about 220° F. for 4 to 6 hours or perhaps longer depending on the initial moisture content.

With prior art hoppers, the temperature profile across the hopper may not be uniform and in some instances prevent some pellets from reaching the appropriate drying temperature. As a result, non-uniform drying of the pellets may cause processing problems. The temperature profile from the bottom to the top of the hopper may also be non-uniform preventing the pellets from reaching the proper drying temperature and remaining for a sufficient time to release their moisture. Again processing problems may result. Depending on where and how the heated drying air is introduced to the hopper, pellets at the bottom of the hopper may not be heated at all. With some hopper designs a quantity of material has to be fed out at the bottom of the hopper during start up operations in order to reach the dry material thereabove. The rate of heat transfer from the air to the inside of the pellets will also vary depending on the method of introducing hot dry air to the pellets. This transfer rate will affect the time necessary for a new hopper full of material to be dry enough to process. Finally, flow through the hopper will not be uniform unless there is a properly designed baffle located above the outlet of the hopper. There is also a tendency for the material to flow down the center leaving material at the sides for excessive periods of time. Thus, the flow through the center may not allow sufficient residence time for the material to dry properly.

It is the object of the present invention to provide a drying hopper operable to dry pellets efficiently and uniformly and in the shortest possible period of time as well as minimizing drying time at startup.

### SUMMARY OF THE INVENTION

In fulfillment of the foregoing object and in accordance with the present invention, hot dry air is introduced to the hopper and is directed through a conduit to a diffuser. The diffuser has an inverted frusto-conical lower section which is perforated to allow the drying air to flow downwardly and outwardly therethrough.

In accordance with the invention, a second or further inverted frusto-conical member or basket is disposed in the hopper between and in spaced relationship with both the hopper wall and the inverted frusto-conical portion of the diffuser. The lower portion of the hopper also takes an inverted frusto-conical configuration and an annular inverted frusto-conical passageway is thus defined between the diffuser and the basket and an annular frusto-conical air chamber is also defined between the exterior of the basket and the frusto-conical section of the hopper. Thus, air flow occurs from the diffuser downwardly and outwardly across the annular passageway and through openings provided in the basket which is also perforated. In the air chamber behind or radially outwardly of the basket the air flows upwardly and is discharged through perforations in the member to pellets thereabove in the hopper.

Further, an upper upright frusto-conical portion of the diffuser is open at both ends and is joined at its lower end to the upper end portion of the inverted frusto-conical portion of the diffuser and has its smaller upper end connected with the hot air supply conduit. Perforations in the upper portion of the diffuser allow heated drying air to flow outwardly and upwardly from the diffuser and into the pellets in the hopper thereabove. A lower end portion of the diffuser is at least partially perforated and is preferably perforated throughout to allow air to flow downwardly and outwardly therethrough. Beneath the lower end portion a cylindrical extension of the basket is provided to collect pellets from the annular passageway and to direct the same downwardly for discharge from the hopper.

The principle advantage of the foregoing hopper design is its highly efficient pellet heating and drying characteristics. The pellets, having first been heated in the upper portion of the hopper are uniformly heated and dried in the aforementioned annular passageway about the lower portion of the diffuser. Both the speed of drying as well as efficiency is enhanced with the construction of the present invention.

In addition to the foregoing the diffuser and its supply conduit may be readily constructed as a single assembly and removed through a hopper door for cleaning and maintenance.

The frusto-conical basket can also be readily removed from the interior of the hopper through the access door for cleaning and maintenance.

The key to the improved drying of the present hopper is believed to reside in the flow of heating and drying air in a substantially continuous and high speed flow from the diffuser through the pellets in the frusto-conical annular passageway and outwardly through the perforated frusto-conical basket. As compared with hopper designs lacking high speed through flow characteristics and wherein the heating and drying air is in a static or slightly turbulent state, the increased velocity of the air through the pellets is believed to reduce the boundary layer of air surrounding and insulating each pellet from being heated and dried. Thus, almost a wind-chill in reverse exists. The overall outstanding result is that many materials can be dried in half or less the time required in prior art hoppers. Faster heating is more important than ever in view of quick material changes required by current “just-in-time” inventories. Machine downtime is reduced substantially.

### DRAWINGS

The single drawing FIGURE illustrates the improved drying hopper of the present invention in schematic sectional form.

### DESCRIPTION OF THE PREFERRED EMBODIMENT

Referring to the drawing, a drying hopper indicated generally at 10 may take an upright cylindrical configuration as shown with a lower portion of the side-bottom wall thereof at 12 taking an inverted frusto-conical configuration. The hopper is insulated throughout as indicated at 14 for the upper portion and 16 for the lower portion thereof. Air diffuser 18 disposed in the interior of the hopper has an inverted frusto-conical lower portion 20 which is perforated and which has a bottom wall 22 which is at least partially open and is preferably also perforated. At its upper and open end the diffuser portion 20 is connected with an upper and upright frusto-conical portion 24 which has a reduced diameter open upper end connected with supply conduit 26. The conduit 26 extends to a fitting 28 in the side wall of the hopper for connection with a supply of heated drying air.

Also disposed within the interior of the lower hopper portion 12 is a further inverted frusto-conical member 30 which may be referred to as a basket and which is disposed in spaced relationship with the diffuser portion 20 and with the wall of the hopper portion 12. The basket 30 is perforated for the free flow of drying air therethrough and is provided at its lower end with a cylindrical portion which collects pellets flowing downwardly through the annular passageway 32 for discharge from the hopper. The annular passageway 32 is defined between the diffuser wall 20 and the basket 30, the longitudinal centerlines of all three frusto-conical members are coincident.

At an upper end portion 34 the basket 30 extends above the diffuser wall 20 and the perforations therein are exposed to the pellets thereabove in the hopper. Thus, as indicated by arrows 38, air flowing outwardly from the diffuser section 20 through the annular passageway 32 and the basket 30 will travel upwardly in the space between the basket and the hopper section 12 and exit at the upper portion 34 for heating of the pellets thereabove.

As will be seen, removal of the diffuser 18 and the supply conduit 26 as a unitary assembly can be readily accomplished through a door 40 as can removal and replacement of the basket 30. At an upper portion of the hopper an exit or discharge fitting 42 may be provided for spent drying air and an opening at 44 may be provided for the introduction of pellets to be conditioned.

As mentioned, highly efficient drying operation is achieved with non-turbulent continuous and substantially linear air flow across the passageway 32 from the diffuser section 20 to and through the pellets in the basket 30. Pellets which may be partially dried in upper portions of the hopper are finally dried to a desired uniform condition in passage through the annular passageway 32 and excellent results are achieved in a most expeditious manner. Maintaining the pellets out of contact with the hopper wall with the basket reduces heat loss and temperature loss in the pellets in this region. Finally, directing the air upwardly for initial pellet heating reduces heat loss at the hopper wall adjacent the basket.

What is claimed:

1. A drying hopper for conditioning plastic resin pellets prior to use in molding or extruding processes; said hopper having side, top, and bottom walls with clean, smooth interior surfaces, and a lower side-bottom wall section in an inverted frusto-conical configuration with an open upper end and an open reduced diameter lower end for discharging pellets, the pellets being introduced to the hopper through a suitable opening at an upper portion thereof, an inverted frusto-conical air diffuser having perforate side walls for the discharge of air therethrough, said diffuser also having a top wall with an entry opening for the introduction of heated air under pressure to its interior, an air supply conduit connected with said entry opening and with a source of heated drying air under pressure, an inverted frusto-conical perforated basket disposed in the hopper between and in spaced relationship with the lower frusto-conical hopper section and the frusto-conical diffuser side-wall, said basket also being perforated and defining in cooperation with the diffuser an inverted frusto-conical annular passageway for uniform drying of the pellets in their downward movement through the annular passageway, pellets in movement through the passageway being subjected to a substantially continuous high speed through flow of heating and drying air from the diffuser across the pellets in the passageway and thence through the basket to a space between the basket and the hopper lower section.

2. A drying hopper as set forth in claim 1 wherein the top wall of the diffuser takes the form of an upright frusto-conical member joined at an open base with the top of the frusto-conical side wall of the diffuser and at an open upper end with the air supply conduit.

3. A drying hopper as set forth in claim 2 wherein said diffuser top wall is perforated for the outward and upward flow of heated drying air from the interior of the diffuser to the hopper interior.

4. A drying hopper as set forth in claim 1 wherein said basket has an integral hollow cylindrical extension at its lower end to collect pellets from the annular passageway for discharge from the hopper.

5. A drying hopper as set forth in claim 1 wherein said basket extends upwardly beyond the upper end of the diffuser and is exposed to pellets stored in the hopper above the lower portion of the diffuser, air passing from the diffuser through the pellets in the annular passageway and outwardly through the perforations in the basket thus flowing upwardly and in reverse direction through the perforations at the upper end portion of the basket to heat and dry pellets thereabove.

6. A drying hopper as set forth in claim 1 wherein the longitudinal centerlines of the lower diffuser section, the basket, and the lower hopper section are coincident.

7. A drying hopper as set forth in claim 1, wherein the diffuser has at least a partially open wall for the downward discharge of heating air into pellets therebeneath as they are discharged from the hopper.
